(19) United States
(12) Patent Application Publication
(10) Pub. No.: US 2016/0042885 A1
(43) Pub. Date: Feb. 11, 2016

(54) Switches, Switch Arrays, And Keyboards Using The Same

(71) Applicant: Dinh Le, Rosemead, CA (US)

(72) Inventor: Dinh Le, Rosemead, CA (US)

(21) Appl. No.: 14/544,701

(22) Filed: Feb. 2, 2014

(51) Int. Cl. H01H 9/26; H01H 13/14; H01H 13/02; H01H 21/22

(52) U.S. Cl. CPC H01H 9/26; H01H 21/22; H01H 13/14; H01H 13/023; H01H 2215/004; H01H 2219/036

(57) ABSTRACT

An m-by-n switch array comprises a frame, switches that anchor around the frame, and threads that connect the switches to their opposing sides of the frame. Applying pressure on a thread pulls the switch, connected to that thread, to its ON state and releasing pressure on the thread lets the switch, connected to that thread, bounces back to its natural OFF state. Applying pressure on an intersection of two threads pulls the two switches, that connected to the two intersected threads, to their ON states while releasing pressure lets those two switches bounce back to their natural OFF states. The position of the intersection, where pressure is applied, can be determined by checking the ON/OFF states of all the switches. Keys can be placed on the thread intersections to emulate devices such as keypads, calculators, remote controls, keyboards, and other key input devices.

### FIELD OF THE INVENTION

The present invention relates to switches, switch arrays, and the devices that utilize them such as keypads, calculators, remote controls, and keyboards.

### DESCRIPTION OF THE RELATED ART

An m-by-n switch array (where m and n are integers) generally comprises m-times-n switches that are laid out on a flat surface with conductive paths connecting from their terminals to the m-plus-n pins of a microprocessor such that when a switch is pushed, two electrical signal changes (from LOW to HIGH or from HIGH to LOW) are picked up by two pins of the microprocessor. The locations of the two pins, where the electrical signal changes are picked up, enable the microprocessor to determine which switch just get pressed. It is possible for the microprocessor to pick up more than one simultaneously pressed keys although there is a limitation and there are some anomalies in those cases.

Switch arrays are being employed by devices such as keyboards, keypads, calculators, remote controls, and mobile phones. In those devices, the number of switches is generally less than but close to the max m-times-n keys capacity the microprocessors are assigned to handle. In those devices, each switch of the switch array is associated with an opaque key with distinguished marking that lies on top of the switch. At the location of each key, there must exist at least three layers: key, switch, and flat sheet with conductive paths.

The disclosed invention reduces the number of layers, at each key position, to just the key and its up/down movement space; thus, allows the derived device's thickness to shrink considerably. Not only that, new qualities (transparent body and double-sided keys) are added and old qualities (comfortable distance of key travel, visibility of keys in darkness, waterproofing capability, and desirable tactile feedback) are retained. Besides reducing the number of layers at each key position, the disclosed m-by-n switch array requires only m-plus-n switches instead of m-times-n switches that are needed by the traditional switch arrays.

### BRIEF DESCRIPTION OF THE INVENTION

The original intention of the invention was to come up with a mobile phone keyboard in a form of a rectangular frame with:
thread triggered switches strategically spaced and anchored on the frame's top and left sides,
transparent threads connected from the switches to their opposite sides (bottom and right sides) of the frame, and
transparent keys with translucent markings placed at the intersections of the horizontal and vertical threads.

Such keyboard would possess qualities—thin, compact, and double-sided typing—that are highly sought after by the mobile device community. During the process of prototyping and making improvements, inventions within invention were derived for broader usages and they include:
levered switch,
thread triggered switch,
single-sided thread triggered switch array,
double-sided thread triggered switch array, and
double-sided key input device.

The detailed description of the invention will reveal how the derived devices are thinner than their counterparts and have more desirable features (transparent body and double-sided keys) while retaining the old qualities (comfortable distance of key travel, visibility of keys in darkness, waterproofing capability, and desirable tactile feedback) of the traditional high end key input devices.

### BRIEF DESCRIPTION OF THE DRAWINGS

The figures are not necessary drawn to scale.

FIG. 1 is an exploded view of a standalone levered switch.

FIG. 2 is an isometric view of a standalone levered switch in its natural OFF state.

FIG. 3 is a side view of a standalone levered switch in its natural OFF state.

FIG. 4 is a back view of a standalone levered switch in its natural OFF state.

FIG. 5 is a side view of a standalone levered switch in its ON state.

FIG. 6 is an isometric view of a standalone levered switch in its ON state.

FIG. 7 is an isometric view of a standalone wire pivot thread triggered switch.

FIG. 8 is an isometric view of a 3-by-3 wire pivot thread triggered switch array.

FIG. 9 is a side view of a standalone PCB pivot thread triggered switch.

FIG. 10 is an isometric view of a standalone PCB pivot thread triggered switch.

FIG. 11 is an isometric view of a 3-by-3 PCB pivot thread triggered switch array.

FIG. 12 is a top view of a key base.

FIG. 13 is an isometric view of a 1-by-1 PCB pivot thread triggered switch array device.

FIG. 14 is a top isometric view of a single-sided key.

FIG. 15 is a side view of a single-sided key.

FIG. 16 is a section side view of a single-sided key.

FIG. 17 is a bottom isometric view of a single-sided key.

FIG. 18 is a bottom isometric view of a 1-by-1 PCB pivot thread triggered switch array device without the key base.

FIG. 19 is a bottom isometric view of a 1-by-1 PCB pivot thread triggered switch array device.

FIG. 20 is a side view of a 1-by-1 double-sided PCB pivot thread triggered key input device.

FIG. 21 is a section side view of a 1-by-1 double-sided PCB pivot thread triggered key input device.

FIG. 22 is a detailed section side view of a double-sided key.

FIG. 23 is a bottom isometric view of a 1-by-1 double-sided PCB pivot thread triggered key input device.

### DETAILED DESCRIPTION

Before describing the disclosed invention in details, important terminologies are defined and some assumptions are made below:
1. A frame is a closed path, in 2D or 3D, with thickness that allows the anchoring of switches on its surfaces and penetration of wires into its body.
2. A hinge is a type of bearing that connects two solid objects, typically allowing only a limited angle of rotation between them.
3. A thread is a thin flexible string that can be transparent, translucent, or opaque and conductive or non-conductive.
4. A switch is an electrical device, with a pressed point, that is OFF in its natural state;

activates to ON when pressure is applied on the pressed point; and bounces back to OFF when pressure is released. A switch has at least one conductive IN terminal, at least one conductive OUT terminal, and at least one pressed point. In the switch's OFF state, there is no conductivity between the IN and OUT terminals. In the switch's ON state, there is conductivity between its IN and OUT terminals.
5. A lever is a device consisting of a rigid body pivoted against a hinge (fulcrum). A lever amplifies an input force to provide a greater output force.
6. A levered switch is a type of switch that comprises a levered button, a hinge, a dome switch, two disconnected conductive terminals on a surface.
7. A thread triggered switch is a type of levered switch with a thread attached to its pressed point such that the switch goes to state ON when pressure is applied on the thread and goes to state OFF when pressure is removed from the thread.
8. A wire pivot thread triggered switch is a type of thread triggered switch that pivots against two u-shaped wires such that when pressure is applied on the thread, the force is transfered to the levered switch's pressed point.
9. A PCB pivot thread triggered switch is a type of thread triggered switch that pivots around two holes on a PCB such that when pressure is applied to the thread, the force is transferred to its levered switch's pressed point.
10. An m-by-n thread triggered switch array device (where m and n are integers) is an array of m-plus-n thread triggered switches strategically placed around a predefined frame and connected to a microprocessor with the necessary circuitry to function as a key input module.
11. A key is a button on a switch array device that users push on to activate an intended switch.
12. It should be noted that references to “an” or “one” embodiment in this disclosure are not necessarily to the same embodiment, and such references mean at least one.
13. It is assumed that the reader is fluent in the arts of and can consult the current literature to become well versed in electronics, microprocessor, firmware, communication protocols, PCB schematic and layout, standard keyboard protocols, standard keyboard firmware, and standard keyboard circuitry.

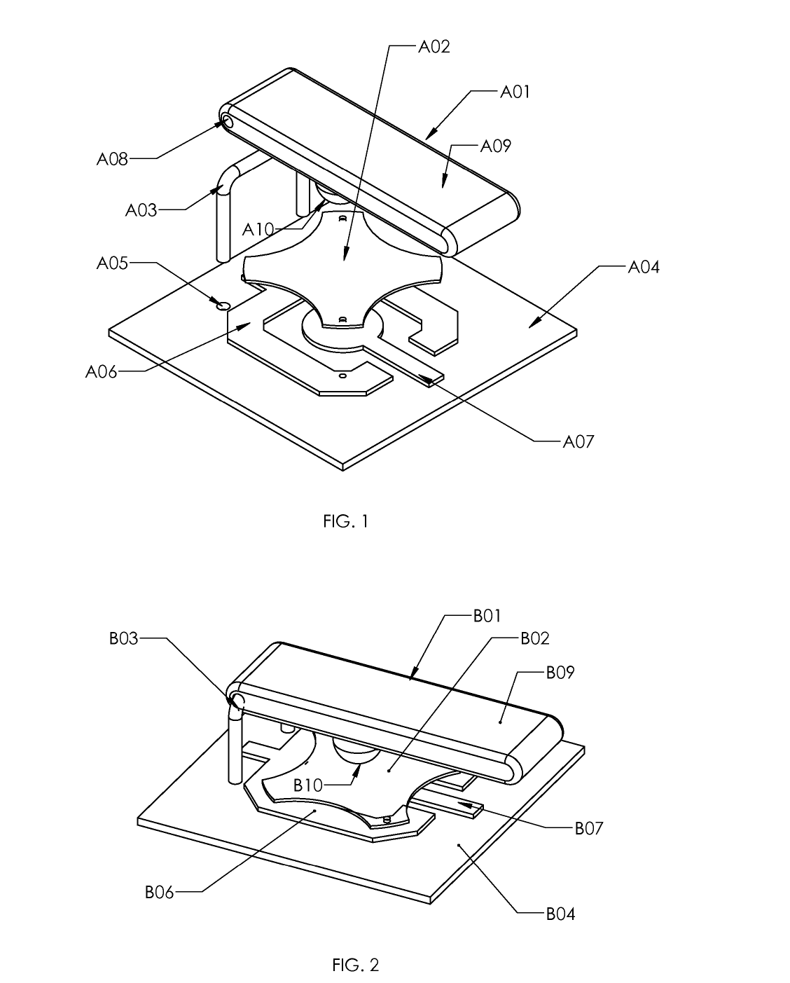

FIG. 1 is an exploded view of a levered switch that comprises a levered button A01, a tactile dome A02, a hinged wire A03, and a printed circuit board A04 with mounting hole A05, conductive IN terminal A06, and conductive OUT terminal A07. The levered button A01 has three points of interests that include the hinged hole A08 (fulcrum), the pressed point A09 (input), and the transferred point A10 (output). The distances between A08, A09, and A10 determine the press-down distance and force (two important parameters measured by the switch industry) needed to change the levered switch's state from OFF to ON. The levered switch allows the designers to experiment with different distance parameters to come up with the most suitable levered switch for their applications.

FIG. 2 is an isometric view of the same levered switch, shown in FIG. 1, in its normal OFF state. The hinge B03 formed by the horizontal portion of wire A03 going through hole A08. Hinge B03 is a fulcrum that enables levered button B01 to rotate around the horizontal cylindrical body of wire A03. If a downward force is applied at point B09, levered button B01 will rotate clockwise around hinge B03; the force at point B09 will get magnified and transfer downward to transferred point B10; the transferred force at transferred point B 10 will then push against the top of conductive tactile dome B02; tactile dome B02 would collapse downward, make a tactile sound, and connect conductive terminals B06 and B07. When the downward force is released, tactile dome B02 would bounce back to its normal OFF form and disconnect the two conductive terminals B06 and B07.

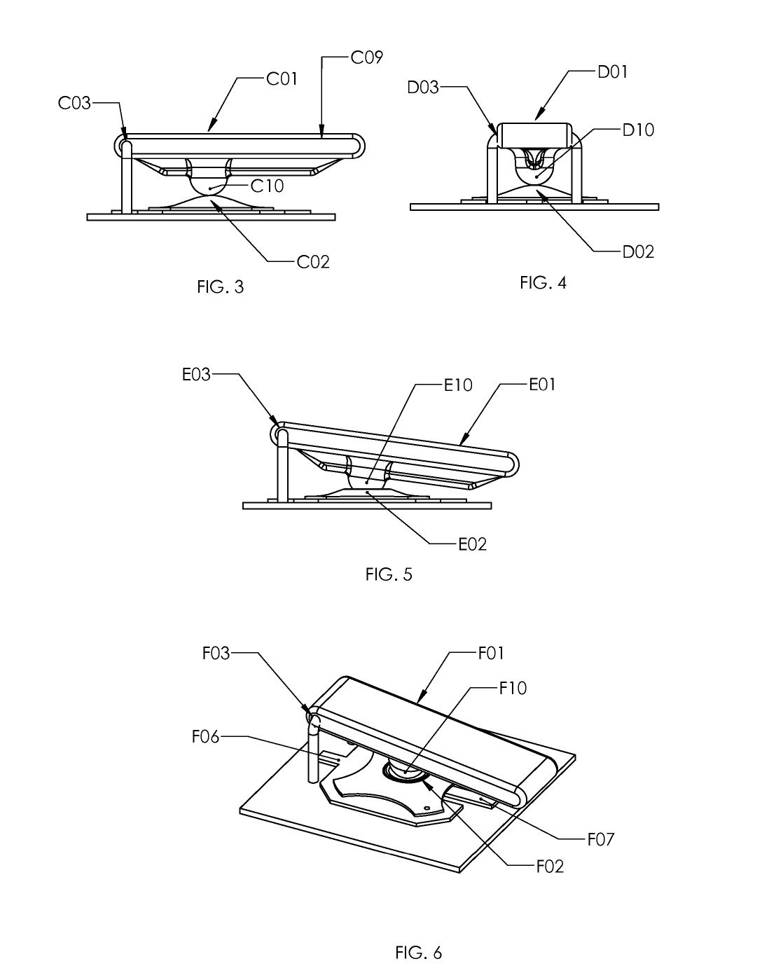

FIGS. 3 and 4 are the side and rear views, respectively, of a levered switch in its OFF state. The concavity of tactile domes C02 and D02 is clearly shown. The levered button C01 illustrates a lever device with fulcrum point C03, input point C09, and output point C10. If the distances between C03 and C09 is d1 and between C03 and C10 is d2 then the magnification coefficient of the lever button is d1/d2. Designers can take advantage of this relation to come up with the most suitable levered switch for their applications.

FIGS. 5 and 6 are the side and isometric views, respectively, of a levered switch in its ON state. FIG. 5 shows, in 2D, tactile dome E02 collapsing downward. FIG. 6 shows, in 3D, tactile dome F02 collapsing downward and touching both IN terminal F06 and OUT terminal F07. In this ON state, the conductive dome connects the two conductive terminals F06 and F07 to establish a conductive path from terminal F06 to terminal F07.

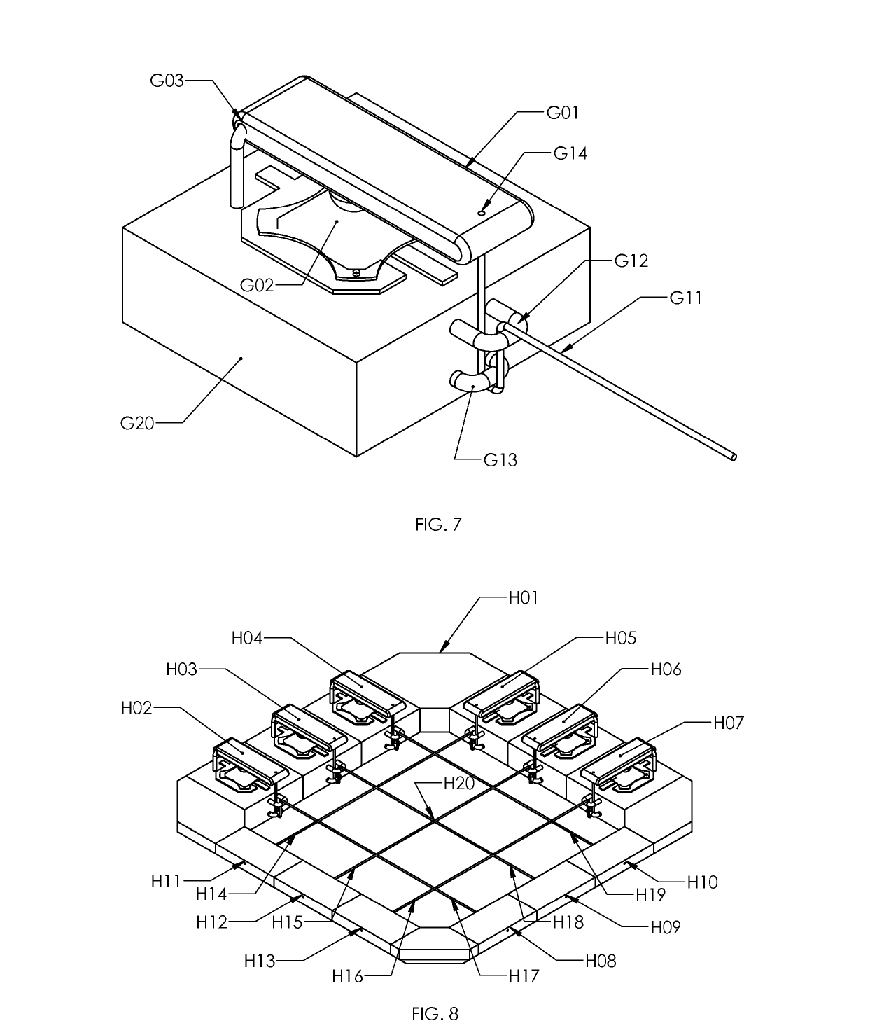

FIG. 7 is an isometric view of a wire pivot thread triggered switch. It is a levered switch with string G11 attached to its levered button pressed point G14, pivoted around the up-down pivot G13 and then pivoted around horizontal/vertical pivot G12. When a pulled up or pushed down force is applied on thread G11, horizontal/vertical pivot G12 and up-down G13 will transfer that force to a downward force at pressed point G14. The downward force at pressed point G14 is similar to a push down force applied to a levered button at pressed point G14.

Thread triggered switches enable the creation of m-by-n thread triggered switch array where m and n are positive integers. FIG. 8 is an isometric view of a 3-by-3 thread triggered switch array. It comprises frame H01 with horizontal thread triggered switches H02, H03, H04 and vertical thread triggered switches H5, H6, H7 anchored on the left and top sides, respectively, of frame H01. Non-intersecting horizontal threads H17, H18, H19 connect thread triggered switches H02, H03, H04 (respectively) to their opposing right-side slots H08, H09, H10 (respectively). Non-intersecting vertical threads H14, H15, H16 connect thread triggered switches H05, H06, H07 (respectively) to their opposing bottom-side slots H11, H12, H13 (respectively). Non-intersecting horizontal threads H17, H18, H19 intersect non-intersecting vertical threads H14, H15, H16 at nine points with H20 being one of them. If a downward force is applied at point H20, thread triggered switches H03 and H06 will get initiated and change their states from OFF to ON, whereas, the other thread triggered switches will remain in states OFF. It is possible to accurately detect multiple pressure points but some combination will cause inaccurate detection. Most other switch array devices (keyboard, keypad, calculator, remote control) suffer the same multiple key presses inaccuracy because they work similarly. From now on, we refer to “other switch arrays” as the other switch arrays that are not “thread triggered switch array”.

Most m-by-n “other switch arrays” require m-times-n switches each, however, an m-by-n thread triggered switch array requires only m-plus-n switches. For instance, if m is 12 and n is 6 then most 12-by-6 “other switch arrays” require 72 switches each, whereas, a 12-by-6 thread triggered switch array requires only 18 thread triggered switches. Furthermore, all “other switch arrays” place all their switches in the middle region where the downward forces are applied, whereas, a “thread triggered switch array” place the thread triggered switches around the frame with a “threads intersected region” occupied the dominant middle region. The threads intersected region is thread thin, transparent, and responsive to both upward and downward force. These qualities make thread triggered switch array devices more compact, lighter, less expensive, easier to clean, and more versatile than “other switch arrays” devices.

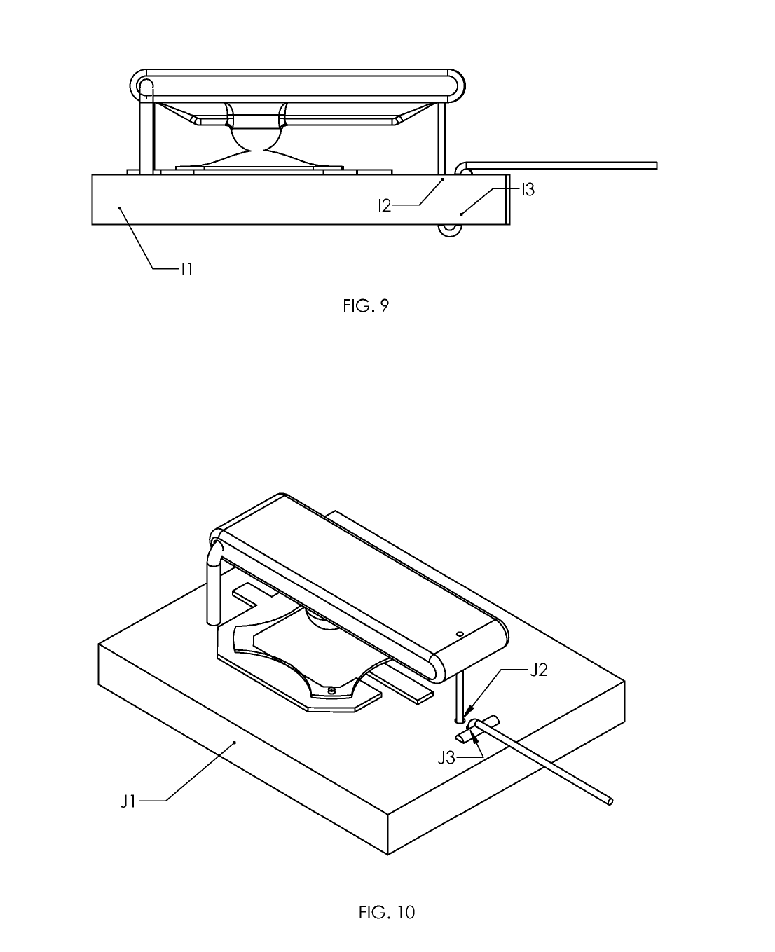

FIGS. 9 and 10 are the side and isometric views, respectively, of a PCB pivot thread triggered switch array, another version of a thread triggered switch. In this version, the frames I1 and J1 are much thinner than the previous version G20 such that Printed Circuit Board technologies can be employed to solder the pins and pads, connect the circuitry, and assemble the components. In this version, two holes I2 (J2) and I3 (J3) right beneath the levered button pressed point are created to allow the thread to pivot downwardly-upwardly and horizontally/vertically to function just like the wire pivot thread triggered switch array shown in FIG. 7. PCB pivot thread triggered switch array is preferred over wire pivot thread triggered switch array because it requires less space, is thinner, and is easier to assemble.

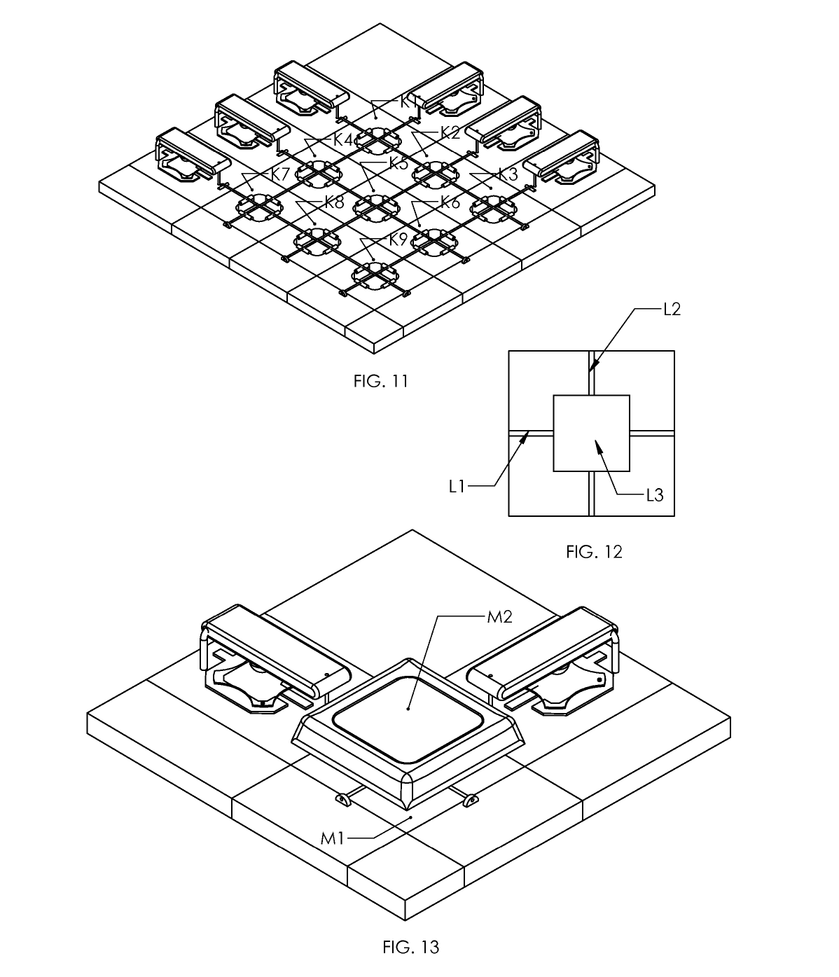

FIG. 11 is an isometric view of a 3-by-3 PCB pivot thread triggered switch array with 9 key bases K1, K2, K3, K4, K5, K6, K7, K8, and K9. FIG. 12 is a top view of a key base with a horizontal thread guide way L1, a vertical thread guide way L2, and an up-down key guide way L3. Horizontal guide way L1 restricts horizontal thread that lies inside the guide way to slide and move horizontally inside the guide way. Vertical guide way L2 restricts vertical thread that lies inside the guide way to slide and move vertically inside the guide way. Guide way L3 restricts a key (to be described next) to move up and down inside the guide way.

FIG. 13 is an isometric view of a 1-by-1 PCB pivot thread triggered switch array with key base M1 and single-sided key M2. The addition of a key base M1 and single-sided key M2 makes it a simple 1-by-1 single-sided thread triggered key input device. To assemble a 1-by-1 single-sided thread triggered key input device, horizontal & vertical threads are threaded through the holes of the cylindrical extrusion base of the single-sided key M2 (see O2 in FIG. 15 ahead); and single-sided key M2 is slid into key guide way L3 and snapped into the key base. Single-sided key M2 is free to move down and bounce up within a limited range.

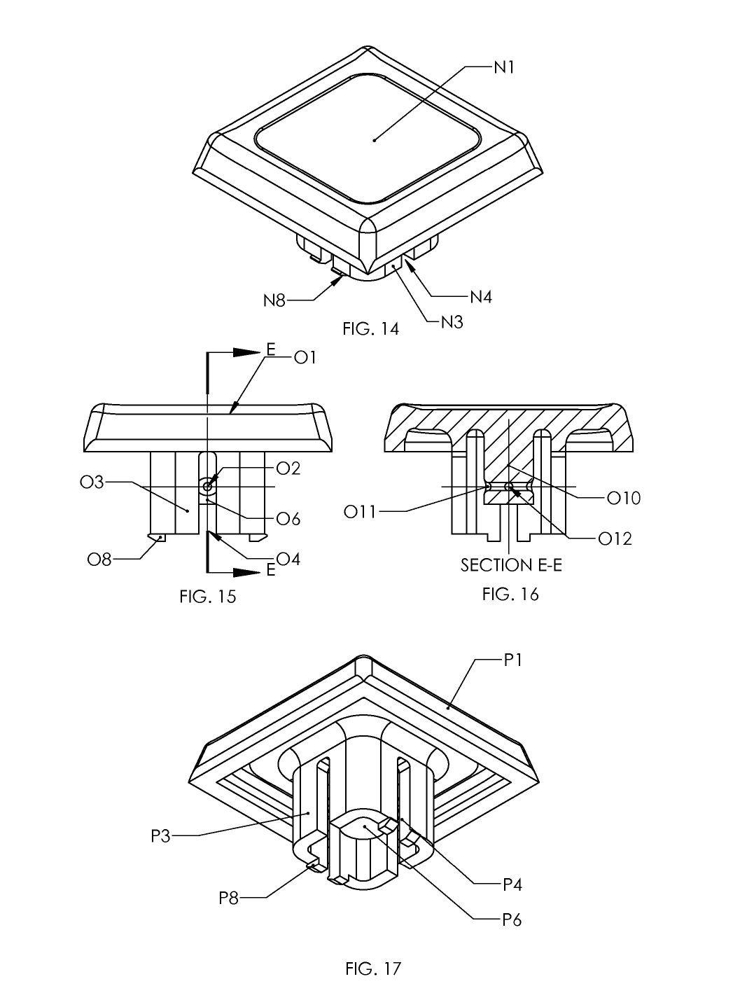

FIG. 14 is a top isometric view of a single-sided key with top cap N1 that interfaces with the user (key press area), guide body N3 that keeps the key confined inside the up-down key guide way, and snap hook N8 that keeps the single-sided key from escaping the key base. FIG. 15 is a side view of a single-sided key. It shows one through hole O2 out of two through holes that are threaded through by a vertical thread and a horizontal thread. Applying downward force on top cap O1 will move hole O2 down and cause the two thread triggered switches, connected to the vertical and horizontal threads going through hole O2, to get initiated and changed to ON states. FIG. 16 is a section side view of the single-sided key. The cylindrical extrusion O10 can clearly be seen with through holes O11 and O12 perpendicularly drilled through its lower part.

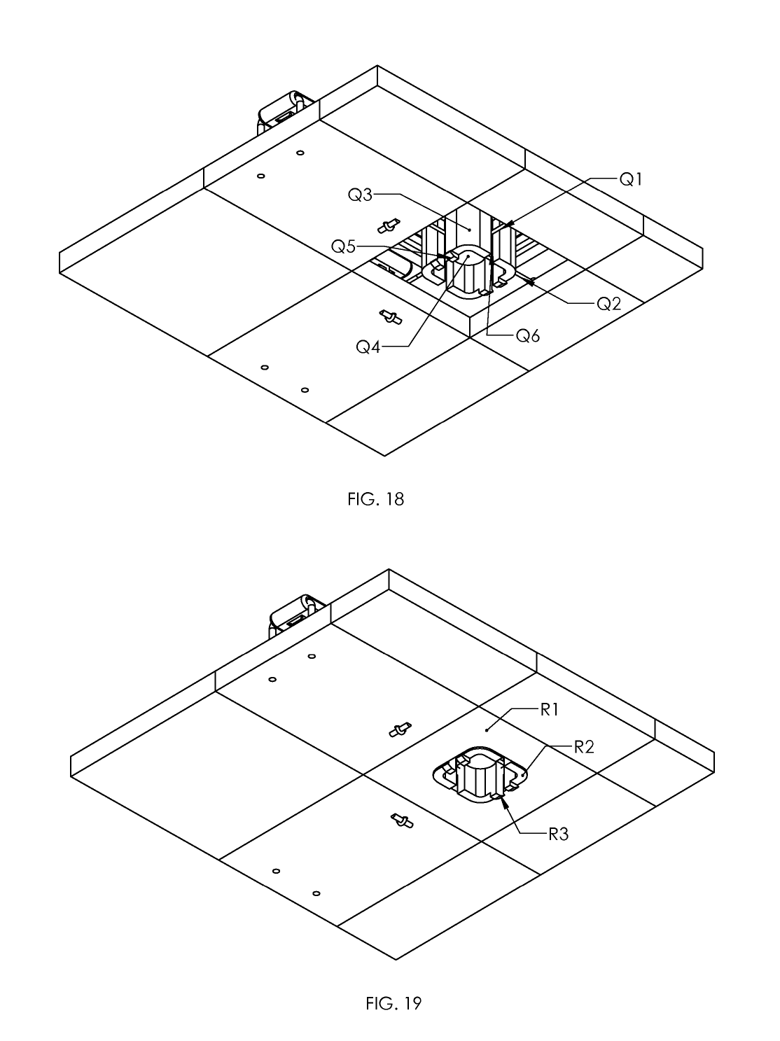

FIG. 17 is a bottom isometric view of a single-sided key with top cap P1, guide body P3, slitted way P4, extruded cylinder P6, and snap hook P8. FIG. 18 is a bottom isometric view of a single-sided key being assembled on a 1-by-1 thread triggered single-sided key input device without the key base to expose the bottom isometric view of the single-sided key. It shows horizontal thread Q1 and vertical thread Q2 threaded through the extruded cylinder Q4. Slit Q6 is one of four slits that allows the key to move up and down freely and leave the job of pulling and releasing horizontal thread Q1 and vertical thread Q2 to the extruded cylinder Q4.

FIG. 19 is a bottom isometric view of a single-sided key being assembled on a 1-by-1 thread triggered switch array with key base R1. Guide body R2 is enclosed inside the key base guide way to restrict the key's movement to up and down. Snap hook R3 prevents the single-sided key from moving upward beyond the key base and damage the threads.

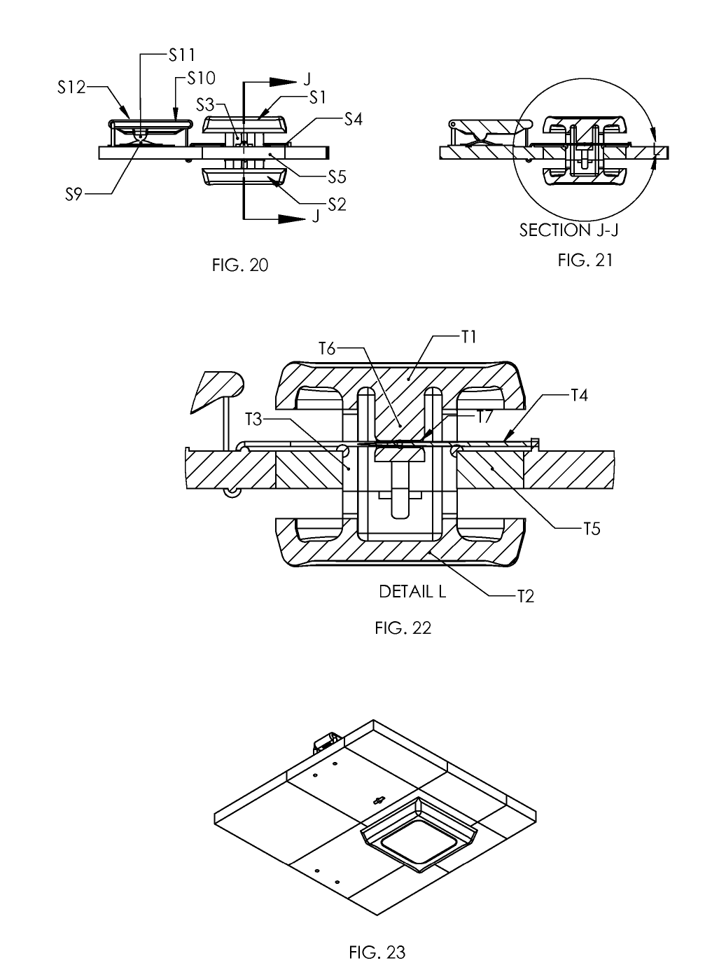

FIGS. 20, 21, and 22 are the side, side section, and detailed side section views, respectively, of a 1-by-1 double-sided thread triggered key input device. Double-sided key is almost exactly like single-sided key except for the followings:
the body guide S3 (T3) protrudes further down passing the key base S5 (T5);
a bottom cap S2 (T2) is added and attached to the bottom of the body guide S3; and
the snap hook is removed.

FIG. 23 is the bottom isometric view of a 1-by-1 double-sided thread triggered key input device. Downward force, relative to the user, can be applied on both top cap (T1) and bottom cap (T2). The two caps prevent the key from escaping the key base. The body guide T3 keeps the key restricted to up and down movement only. The cylindrical extrusion T6 stays unchanged. Thread T4 is shown, in FIG. 22, threading through hole T7, one of cylindrical extrusion two through holes. With dome S9 keeping thread S4 tensioned, the double-sided key threaded through by thread S4 will stay in its natural OFF state. When a downward force, relative to the user, on top cap S1 or bottom cap S2 is applied, it will collapse dome S9 downward and cause switch S12 to change to ON state. This is the same levered switch mechanism that was described previously.

Double-sided keyboard that hinges onto the mobile phone would enable the user to see the faint translucent markings of the keys and through the transparent body of the keys, key bases, and threads. In its closed state, the user can see data being entered although the view can be slightly obstructed by the key markings and imperfect transparency of the keys, key bases, and threads. In its opened state, the view is perfectly clear and the keyboard is thin, light, compact, and possess the desired properties of quality mechanical keyboard. A double-sided mobile phone keyboard gives its user the convenience of answering/calling/checking while the keyboard is closed and the power of a full keyboard typing when performing more sophisticated tasks like composing emails, searching the web, or writing memos.

Before making claims, merits of the disclosed inventions—levered switch, thread triggered switch, single-sided thread triggered switch array, double-sided thread triggered switch array, and double-sided key input device—are summarized below:
Levered switch enables designers to experiment with different lengths between input, fulcrum, and output points to find the pressed down force and distance that best suit their applications.
Levered switch allows pressed point to have empty space underneath so that a thread can be attached and hung down without obstruction.
Thread triggered switch allows pressure to be applied anywhere on the thread not just at the levered switch's pressed point.
An m-by-n thread triggered switch array only requires m-plus-n switches instead of m-times-n switches like the “other switch arrays”.
Thread triggered switch array has very thin and transparent dominant middle region.
Thread triggered switch array can be used as a surface sensor.
Thread triggered switch array can operate on both top and bottom sides.
Thread triggered switch array is easy to clean and be constructed to work under water.
Thread triggered switch array can employ transparent conductive threads to light up and decorate the keys they are aligned with.
Single-sided key enables the thinnest body possible for a thread triggered key input device.
Double-sided key can have two independent keys in the same space.
Double-sided thread triggered key input device enables two key layouts occupying in the same space.
Thread triggered switch allows pressure to be applied anywhere on the thread not just at the pressed point.
An m-by-n thread triggered switch array only requires m-plus-n switches instead of m-times-n switches like the “other switch arrays”.
Thread triggered switch array has very thin and transparent dominant middle region.
Thread triggered switch array can be used as a surface sensor.
Thread triggered switch array operates on both top and bottom sides.
Thread triggered switch array is easy to clean and be constructed to work under water.
Thread triggered switch array can employ transparent conductive threads to light up and decorate the keys they are aligned with.
Single-sided key enables the thinnest body possible for a thread triggered key input device.
Dynamic thread triggered key input device enables dynamic switching of different key input layout—English, Chinese, Scientific, Chemistry, and so on.
Double-sided key can have two independent keys in the same space.
Double-sided thread triggered key input device enables two key layouts occupying in the same space. For instance, in a clam shell configuration, a closed clam shell key input device can have a one handed vertical layout while an opened clam shell can have a full qwerty keyboard layout.

What is claimed is:

1. A levered switch comprising:
a levered button with three points—pressed, fulcrum, and transfered;
a base with conductive IN and OUT terminals;
a conductive springy resilient dome standing and soldering on one base's terminal and hovering over the other base's terminal;
a hinge mechanism that hinged with the lever button at the fulcrum and positioned such that the levered button's transfered point is standing on top of the dome.

2. A levered switch as claimed in claim 1, wherein the hinge mechanism comprises a u-shaped wire implanted on the base and the levered button with a through hole at the fulcrum such that the levered switch can rotate at the fulcrum point to push down and collapse the resilient dome.

3. A levered switch as claimed in claims 1 and 2, wherein their components have the following options: resilient dome is tactile or non-tactile; button is conductive or non-conductive;

4. A thread triggered switch comprising a levered switch as claimed in claim 3, wherein a thread is attached to the pressed point of the levered button, hung down toward the base, pivoted down-upwardly and horizontally/vertically, and tensioned such that a force applied to the exposed thread will turn the thread triggered switch to its ON state.

5. A thread triggered switch as claimed in claim 4, wherein its base possesses sufficient thickness to implement an down-up and horizontal/vertical pivot scheme where two u-shape wires are implanted on the base's vertical surface and be situated under the hung thread so that the thread can pivot under and over around them down-upwardly and horizontally/vertically.

6. A thread triggered switch as claimed in claim 4, wherein its base is a PCB with two holes under the hung thread and lubricated padding so that the hung thread can pivot under and over around the holes down-upwardly and horizontally/vertically.

7. A thread triggered switch as claimed in claims 4, 5, and 6, wherein the thread can be conductive or non-conductive and transparent, translucent, or opaque.

8. An m-by-n (m and n are positive integers) thread triggered switch array comprising:
m-plus-n thread triggered switches each of which is a thread triggered switch as claimed in claim 7,
a frame joining all the thread triggered switches' bases and extending the base such that:
it forms a closed path;
m non-intersecting threads from m thread triggered switches intersect all n non-intersecting threads from the other n thread triggered switches forming m-times-n intersections;
m-plus-n threads are tensioned, without turning any of the switches to their ON state, and tied to their opposite side of the frame; and
the area underneath all thread intersections is empty space.

9. A thread triggered switch array as claimed in claim 8, wherein the frame and switches are enclosed in an enclosure such that:
the enclosure does not interfere with the switches and threads motion,
the enclosure does not block the thread intersections,
the enclosure stay as close to the frame as possible,
the enclosure has escaped holes for the threads so that they do not violate the conditions above while achieving the goal of staying as close to the frame as possible, and
the escaped holes do not let water or moisture getting inside the enclosure.

10. A thread triggered switch array device comprises a thread triggered switch array as claimed in claim 8 or claim 9, key bases and single-sided keys such that:
a key base has an up-down key guide hole, a horizontal and vertical thread guide ways;
a single-sided key has a top cap, an up-down guide body, a cylindrical extrusion with two perpendicularly intersected through holes go through its lower body, and two snap hooks to keeps the single-sided key from escaping the key base;
O at each thread intersection, the horizontal and vertical threads are threaded through the two perpendicularly intersected through holes of the single-sided key's cylindrical extrusion;
beneath each thread intersection is a key base that holds the single-sided key in its guide hole and restricts its movement to up-down only;
at each key base, the horizontal and vertical threads are aligned in the key base's horizontal and vertical guide ways that restrict those threads movement to horizontal and vertical, respectively; and
the key bases are joined into one solid body—the switch array base.

11. A thread triggered switch array device comprises a thread triggered switch array as claimed in claim 8 and claim 9, key bases and double-sided keys such that:
a key base has an up-down key guide hole, a horizontal and vertical thread guide ways;
a double-sided key has a top cap, an up-down guide body, a cylindrical extrusion with two perpendicularly intersected through holes go through its lower body, and a bottom cap.
at each thread intersection, the horizontal and vertical threads are threaded through the two perpendicularly intersected through holes of the double-sided key's cylindrical extrusion;
beneath each thread intersection is a key base that holds the double-sided key in its guide hole and restricts it to move up-down only;
at each key base, the horizontal and vertical threads are aligned in the key base's horizontal and vertical guide ways that restrict those threads movement to horizontal and vertical, respectively; and
The key bases are joined into one solid body—the switch array base.

12. A thread triggered switch array device as claimed in claim 10, wherein the threads are transparent, the single-sided keys are transparent, the switch array base is transparent, and beneath the switch array base is a display unit that cover the entire switch array base.

13. A thread triggered switch array device as claimed in claim 12, wherein the display unit is a flat display unit such as LCD, TFT, flexible display, paper display, illustrative card, illustrative fabric, illustrative paper, etc.

14. A thread triggered switch array device as claimed in claim 11, wherein the threads are transparent, the double-sided keys are transparent, the switch array base is transparent, and a hinge mechanism is added such that the switch array device can hinge with another device, such as a mobile phone, a tablet, or a phone-tablet.

15. A double-sided keyboard clam shell device comprising a thread triggered switch array device as claimed in claim 14 hinging with an intelligent device that can utilize the thread triggered switch array device as claimed in claim 14 as a key input device such that:
in its closed state, side one of the double-sided switch array device is the acting key input device, and
in its opened state, side two of the double-sided switch array device is the acting key input device.

16. A double-sided keyboard clam shell device as claimed in claim 15, wherein the intelligent device is a mobile phone, a tablet, or a phone-tablet.

17. A thread triggered switch array device as claimed in claim 10, wherein the threads are conductive and each single-sided key has a light emitting diode with terminals that connect to the conductive horizontal and vertical threads that intersect at the key.

18. A thread triggered switch array device as claimed in claim 11, wherein the threads are conductive and each double-sided key has a light emitting diode with terminals that connect to the conductive horizontal and vertical threads that intersect at the key.
